(19) United States
(12) Patent Application Publication
(10) Pub. No.: US 2002/0121446 A1
(43) Pub. Date: Sep. 5, 2002

(54) Fluoro-alpha, omega-bis[(fluoroalky)fluorophosphorano)]alkanes, and process for their preparation

(75) Inventors: Michael Schmidt, Seeheim-Jugenheim (DE); Andreas Kuhner, Darmstadt (DE); Nikolai Ignatyev, Duisburg (DE); Peter Sartori, Utting (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: MERCK KGAA, Darmstadt (DE)

(21) Appl. No.: 10/084,681

(22) Filed: Feb. 28, 2002

(30) Foreign Application Priority Data
Feb. 28, 2001 (DE) 101 09 756.5

(51) Int. Cl. C25B 3/08; C25B 3/06; C07F 9/02

(52) U.S. Cl. 205/461; 205/430; 568/8

(57) ABSTRACT

The present invention relates to fluoro-α,ω-bis[(fluoroalkyl)fluorophosphorano)]alkanes, to a process for their preparation, and to their use as intermediates.

The present invention relates to fluoro-α,ω-bis[(fluoroalkyl)fluorophosphorano)]alkanes, to a process for their preparation, and to their use as intermediates.

Perfluoroalkylfluorophosphoranes are useful starting materials for the synthesis of diverse fluorinated organophosphorus compounds which have a whole series of practical applications [P. Sartori and N. Ignatyev, WO 98/15562 (Merck KGaA); V. Ya. Semenii, V. N. Zavatchskii, N. I. Liptuga and L. M. Yagupolskii, USSR Patent No.498311 (1976); N. V. Pavlenko, V. N. Zavatchskii, V. Ya. Semenii, G. I. Matyuschecheva and L. M. Yagupolskii, Zh. Obshch. Chim. (Russ.), 59 (1989), pp. 534-537; N. V. Pavlenko and L. M. Yagupolskii, Zh. Obshch. Chim. (Russ.), 59 (1989), pp. 528-534].

Fluoro-α,ω-bis[(fluoroalkyl)fluorophosphorano)]alkanes have 2 phosphorus reaction centers, which thus offer additional possibilities for their use as ligands in organometallic chemistry. For example, Kampa et al., Agnew. Chem. Int. Ed. Engl. (1995), 34. No. 11, pp. 1241-1244 discloses perfluoro-1,2-bis(diethyldifluorophosphorano)ethane. However, processes for the preparation of these fluoro-α,ω-bis[(fluoroalkyl)fluorophosphorano)]alkanes, in particular in commercially relevant amounts, are currently not available.

A method for the electrochemical fluorination of alkylphosphines or phosphoranes (A) having a variable number of phosphorus-bonded alkyl radicals has recently been developed [U. Heider, V. Hilarius, P. Sartori and N. Ignatyev, DE 198 46 636 A1; U.S. Pat. No. 6,264,818 B1 (1998) (Merck KGaA)]. This method allows the synthesis of perfluoroalkylphosphoranes (B) of various structures in high yields.

(CₙH₂ₙ₊₁)_{y}PX_{z-y}→(CₙF₂ₙ₊₁)_{y}PF_{5-y} (A)(B)

in which X═H, Cl or F; y=1−3; z=3 (X═H, Cl or F) or z=5 (X═Cl or F); and n≧1

The possibility of using this method for the synthesis of fluoro-α,ω-bis[(fluoroalkyl)fluorophosphorano)]alkanes was unexpected for the person skilled in the art since the analogous electrochemical fluorination of N,N,N⁻,N⁻-tetramethylenediamine, which is the closest to 1,2-bis(diethylphosphino)ethane, is associated with a strong decomposition reaction of the starting material, and a complex mixture of perfluorinated and partially fluorinated compounds is formed [P. Sartori, D. Velayutham, N. Ignatyev and M. Noel, J. Fluorine Chem., 83 (1997), pp. 1-8].

The object of the present invention was therefore to provide fluoro-α,ω-bis[(fluoroalkyl)fluorophosphorano)]alkanes.

This object is achieved by the provision of fluoro-α,ω-bis[(fluoroalkyl)fluorophosphorano)]alkanes of the general formula (I)

(CₙF₂ₙ₊₁₋ₘHₘ)_{y}PF_{4-y}(CR₁R₂)ₓPF_{4-y}(CₙF₂ₙ₊₁₋ₘHₘ)_{y} (I)

in which

1≦n≦8,

0≦m≦2 for n=1 or 2,

0≦m≦4 for 3≦n≦8,

1≦x≦12,

0≦y≦2, and

where R₁ and R₂ are identical or different and are selected from the group consisting of fluorine, hydrogen and alkyl, fluoroalkyl and perfluoroalkyl substituents, and

where the substituents (CₙF₂ₙ₊₁₋ₘHₘ)_{y} and/or the number of these substituents on the phosphorus centers PF_{4-y} are in each case identical or different, and

the compound perfluoro-1,2-bis(diethyldifluorophosphorano)ethane is excluded.

Preference is given to fluoro-α,ω-bis[(fluoroalkyl)fluorophosphorano)]alkanes of the general formula (I) according to the invention in which 1≦n≦6, preferably 1≦n≦3.

Furthermore, preference is also given to fluoro-α,ω-bis[(fluoroalkyl)fluorophosphorano)]alkanes of the general formula (I) in which 1≦x≦8, preferably 1≦x≦4.

Particular preference is given to fluoro-α,ω-bis[(fluoroalkyl)fluorophosphorano)]alkanes of the general formula (I) in which m=0.

Particular preference is also given to fluoro-α,ω-bis[(fluoroalkyl)fluorophosphorano)]alkanes of the general formula (I) in which y=2.

Very particular preference is given to the fluoro-α,ω-bis[(fluoroalkyl)fluorophosphorano)]alkanes of the general formula (I) according to the invention in which R₁ and R₂ are fluorine atoms.

Very particular preference is given to the fluoro-α,ω-bis[(fluoroalkyl)fluorophosphorano)]alkanes of the general formula (I) according to the invention in which R₁ and R₂ are fluorine atoms and m=0.

Where R₁ and R₂ are or contain aklyl, the carbon atom range is preferably C₁ to C₃, with alkyl is preferably a perfluoralkyl (or a fluoralkyl) substituent. In other words: a formula I is preferred where all or almost all H atoms are substituted by F atoms.

The present invention furthermore also relates to a process for the preparation of the fluoro-α,ω-bis[(fluoroalkyl)fluorophosphorano)]alkanes of the general formula (I) according to the invention.

Surprisingly, it has been found that fluoro-α,ω-bis[(fluoroalkyl)fluorophosphorano)]alkanes can be obtained in good yield from α,ω-bis(alkylphosphino)alkanes by electrolysis in hydrogen fluoride.

The advantage of the process according to the invention lies in the use of uncomplicated technology and the omission of expensive auxiliaries, such as helium and fluorinated solvents. In addition, the process according to the invention can be carried out with sufficient amounts of starting material and, besides precise product analysis, also allows commercial utilization.

Preference is given to a process for the preparation of fluoro-α,ω-bis[(fluoroalkyl)fluorophosphorano)]alkanes of the general formula (I)

(CₙF₂ₙ₊₁₋ₘHₘ)_{y}PF_{4-y}(CR₁R₂)ₓPF_{4-y}(CₙF₂ₙ₊₁₋ₘHₘ)_{y} (I)

in which 1≦n≦8, 0≦m≦2 for n=1 or 2, 0≦m≦4 for 3≦n≦8, 1≦x≦12, 0≦y≦2, and

where R₁ and R₂ are identical or different and are selected from the group consisting of fluorine, hydrogen and alkyl, fluoroalkyl and perfluoroalkyl substituents, and

where the substituents (CₙF₂ₙ₊₁₋ₘHₘ)_{y} and/or the number of these substituents on the phosphorus centers PF_{4-y} are in each case identical or different,

in which at least one α,ω-bis(alkylphosphino)alkane or α,ω-bis[(alkyl)halophosphorano]alkane is converted into at least one compound of the general formula (I) by electrolysis in hydrogen fluoride, and this is, where appropriate, purified and/or isolated.

Particular preference is given to a particular variant of the process according to the invention in which at least one compound of the general formula (II)

(CₐH₂ₐ₊₁)_{b}P(R¹)_{2-b}(CH₂)_{c}P(R¹)_{2-b}(CₐH₂ₐ₊₁)_{b} (II)

in which R¹ =H, Cl or F, 1≦a≦8, b=0, 1 or 2 and 1≦c≦12, and/or at least one compound of the general formula (III)

(CₐH₂ₐ₊₁)_{b}P(R²)_{4-b}(CH₂)_{c}P(R²)_{4-b}(CₐH₂ₐ₊₁)_{b} (III)

in which R²=Cl or F, 1≦a≦8, b=0, 1 or 2 and 1≦c≦12,

where the ligands (CₐH₂ₐ₊₁), R¹ and R² in the compounds (II) and/or (III) are in each case identical or different,

is converted into a compound of the general formula (I) by electrolysis in hydrogen fluoride, and this is, where appropriate, purified and/or isolated.

The oxidation state of the P atoms in Formula II (phosphine) and III (phosphorane) are different. The fluorination is an oxidative process that leads to the same formula I in both cases. Therefore after fluorination R¹ and R² of formula II and III are always F in the product formula I.

The electrolysis in the process according to the invention is preferably carried out at a temperature of from −20 to +40° C., particularly preferably from −10 to +10° C. and very particularly preferably from −5 to +50° C.

The electrolysis according to the invention can be carried out in any desired cell known to the person skilled in the art. Electrolysis cells of this type can also be operated under superatmospheric pressure.

The electrolysis of α,ω-bis(alkylphosphino)alkanes is preferably carried out at an excess pressure (pressure above atmospheric pressure) of from 0 to 3 bar, particularly preferably from 0.1 to 1.5 bar and very particularly preferably at atmospheric pressure.

The electrolysis processes according to the invention are preferably carried out at a voltage of from 4 to 8 volts, preferably at 4.5-7.5 volts.

The electrolysis processes according to the invention are preferably carried out at a current density of from 0.2 to 5 A/dm², particularly preferably from 0.2 to 4 A/dm², very particularly preferably at from 0.5 to 2.5 A/dm².

Suitable methods for the purification and/or isolation of the compounds of the general formula (I) are preferably extraction, phase separation, distillation or a combination of these methods.

Preference is given to processes according to the invention in which the electrolysis is carried out using a positive electrode based on nickel. The negative electrode is freely selectable. It may, for example, be made of nickel or alternatively of steel.

In contrast to the perfluoroalkylphosphoranes known hitherto, the fluoro-α,ω-bis[(fluoroalkyl)fluorophosphorano)]alkanes of the general formula (I) according to the invention have two phosphorus reaction centers. These novel compounds therefore offer the possibility of preparing novel organometallic ligands.

A further aspect of the present invention therefore relates to compounds obtained using at least one compound of the general formula (I) as intermediates in the production of materials detailed below.

For example, the fluoro-α,ω-bis[(fluoroalkyl)fluorophosphorano)]alkanes of the general formula (I) according to the invention can be used as starting materials for the preparation of salts having monovalent to trivalent cations, for example lithium or tetraalkylammonium salts. These salts and mixtures thereof are suitable for use in electrochemical cells, primary and secondary lithium ion batteries, capacitors and supercapacitors. They can be employed as conductive salts or additives. They can likewise be used in proportions of between 1 and 99% in combination with other conductive salts that are used in electrochemical cells. Suitable are, for example, conductive salts selected from the group consisting of LiPF₆, LiBF₄, LiClO₄, LiAsF₆, LiCF₃SO₃, LiN(CF₃SO₂)₂, LiN(CF₃CF₂SO₂)₂ and LiC(CF₃SO₂)₃, and mixtures thereof.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius and, all parts and percentages are by weight, unless otherwise indicated.

The entire disclosure[s] of all applications, patents and publications, cited above or below, and of corresponding German Application No. 10109756.5, filed Feb. 28, 2001, is hereby incorporated by reference.

### EXAMPLE

### Example 1

### Synthesis of perfluoro-1,2-bis[(diethyl)difluorophosphorano)ethane

(C₂F₅)₂PF₂-CF₂-CF₂-F₂P(C₂F₅)₂

This compound was prepared by the Simons method by electrochemical fluorination of 1,2-bis(diethylphosphino)ethane in an electrochemical cell using hydrogen fluoride as solvent. A cylindrical stainless-steel cell having a total capacity of 310 ml and a pair of nickel positive electrodes (having an effective positive-electrode area of 3.75 dm²) and negative electrodes having the same effective area were used. The cell was fitted with a condenser for the condensation of the hydrogen fluoride vapour. The temperature of the cell was set at 0° C. and the temperature of the condenser at −30° C. 38.5 g of a 25.3% solution of 1,2-ethanediylbis(diethylphosphine) in hydrogen-fluoride were added in two portions (26.0 g at the beginning, 12.5 g after 31.7 Ah) to 235 g of liquid hydrogen fluoride which had previously been electrolysed in the cell for 19 hours. The gaseous products from the cell were passed through the condenser and through an FEP trap (FEP=tetrafluoroethylene-hexafluoropropylene copolymer) at −78° C. The actual electrolysis took place at a voltage of from 4.8 to 5.3 volts (cell voltage) and a current density of from 0.24 to 0.53 A/dm² and was complete after consumption of 104 Ah of current (154% of the theoretical value). After completion of the electrolysis, the liquid phase was removed from the cell via a separator, and the perfluorinated product was withdrawn from the bottom. In total, the cell yield was 13 g of a transparent liquid which, according to ¹⁹F and ³¹P NMR spectra, comprised about 60 mol % of perfluoro-1,2-bis(diethyldifluorophosphorano)ethane and about 40 mol % of tris(pentafluoroethyl)difluorophosphorane. The yield of perfluoro-1,2-bis(diethyldifluorophosphorano)ethane was 23%. Fractional distillation enabled these substances to be isolated as pure products, which were characterised by ¹⁹F and ³¹P NMR spectra. To this end, the liquid was measured in a FEP tube without solvent using a special method (CD₃COCD₃ film). CCl₃F served as external reference in the film. The frequency of 566.22 Hz of 85% H₃PO₄ in water as reference with acetone-D₆ film was separately determined experimentally. Both the ¹⁹F and ³¹P NMR spectra were measured using a Bruker DRX 500 spectrometer (470.6 MHz for ¹⁹F and 202.5 MHz for ³¹P).

¹⁹F NMR: −48.72 dm (4 F, 2 PF₂); −83.46 tm (12 F, 4 CF₃); −107.73 dm (4 F, 2 CF₂); −114.61 dm (8 F, 4 CF₂); J¹_{P,F}=1016 Hz; J²_{P,F}=122.0 Hz: J²_{P,F}=120.4 Hz; J⁴_{F,F}=9.6 Hz

³¹P NMR: −46.30 tm; J³_{P,P}=44.6 Hz

### Example 2

### Synthesis of perfluoro-1,2-bis[di(i-butyl)difluorophosphorano]ethane

(i-C₄F₉)₂PF₂-CF₂-CF₂-F₂P(C₄F₉)₂

This compound was prepared by the Simons method by electrochemical fluorination of 1,2-bis[di(i-butyl)phosphino]ethane in an electrochemical cell using hydrogen fluoride as solvent. A cylindrical stainless-steel cell having a total capacity of 360 ml and a pair of nickel positive electrodes (having an effective positive-electrode area of 4.85 dm²) and negative electrodes having the same effective area were used. The cell was fitted with a condenser for the condensation of the hydrogen fluoride vapour. The temperature of the cell was set at 0° C. and the temperature of the condenser at −30° C. 135 g of a 46.2% solution of 1,2-bis[di(i-butyl)phosphino]ethane in hydrogen fluoride were added in six portions (31.0 g at the beginning, 15.5 g after 38.9 Ah, 26.0 g after 85.7 Ah, 24.0 g after 143.0 Ah, 26.0 g after 185.5 Ah, 13.0 g after 234.3 Ah) to 335 g of liquid hydrogen fluoride which had previously been electrolysed in the cell for 28 hours. The gaseous products from the cell were passed at −78° C. through the condenser into an FEP trap. The electrolysis reaction took place at a voltage of from 4.4 to 5.3 volts (cell voltage) and a current density of from 0.44 to 0.55 A/dm² and was complete after consumption of 431.3 Ah of current (102.3% of the theoretical value). After completion of the electrolysis, the liquid phase was removed from the cell via a separator, and the perfluorinated product was withdrawn from the bottom. In total, the yield was 136 g of a transparent liquid which, according to ¹⁹F and ³¹P NMR spectra, comprised perfluoro-1,2-bis[(di(i-butyl)difluorophosphorano]ethane and an isomer mixture of perfluoro-1,2-bis[(dibutyl)difluorophosphorano]ethanes with nonafluoro-i-butyl and nonafluoro-n-butyl radicals in different positions of the diphosphoranoethane, and about 20% of partially fluorinated compounds. The yield of perfluoro-1,2-bis[di(i-butyl)difluorophosphorano]ethane was between 10 and 15%.

Fractional distillation enabled perfluoro-1,2-bis[di(i-butyl)difluorophosphorano]ethane to be isolated as the main product, which were characterised by ¹⁹F and ³¹P NMR spectra.

To this end, the liquid was measured in a FEP tube without solvent using a special method (CD₃COCD₃ film). CCl₃F served as external reference in the film. The frequency of 566.22 Hz of 85% H₃PO₄ in water as reference with acetone-D₆ film was separately determined experimentally. Both the ¹⁹F and ³¹P NMR spectra were measured using a Bruker DRX 500 spectrometer (470.6 MHz for ¹⁹F and 202.5 MHz for ³¹P).

¹⁹F NMR: −48.88 dm (4 F, 2 PF₂); −74.12 m (24 F, 8 CF₃); −100.52 dm (8 F, 4 CF₂); −107.01 dm (4 F, 2 CF₂); −180.75 m (4 F, 4 CF); J¹_{P,F}=1035 Hz; J²_{P,F}=121.0 Hz:

³¹P NMR: −40.5 tm

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

We claim:

1. A fluoro-α,ω-bis[(fluoroalkyl)fluorophosphorano)]alkane of formula (I)
(CₙF₂ₙ₊₁₋ₘHₘ)_{y}PF_{4-y}(CR₁R₂)ₓPF_{4-y}(CₙF₂ₙ₊₁₋ₘHₘ)_{y} (I)
in which
1≦n≦8,
0≦m≦2 for n=1 or 2,
0≦m≦4 for 3≦n≦8,
1≦x≦12,
0≦y≦2, and
where R₁ and R₂ are each independently fluorine, hydrogen, alkyl, fluoroalkyl or perfluoroalkyl,
and each substituent (CₙF₂ₙ₊₁₋ₘHₘ) and the number Y of the substituents on phosphorus centers PF_{4-y} are each independently selected,
with the proviso that perfluoro-1,2-bis(diethyldifluorophosphorano)ethane is excluded.

2. A fluoro-α,ω-bis[(fluoroalkyl)fluorophosphorano)]alkane according to claim 1, wherein 1≦n≦6.

3. A fluoro-α,ω-bis[(fluoroalkyl)fluorophosphorano)]alkane according to claim 1, wherein 1≦n≦3.

4. A fluoro-α,ω-bis[(fluoroalkyl)fluorophosphorano)]alkane according to claim 1 wherein 1≦x≦8.

5. A fluoro-α,ω-bis[(fluoroalkyl)fluorophosphorano)]alkane according to claim 1 wherein 1≦x≦4.

6. A fluoro-α,ω)-bis[(fluoroalkyl)fluorophosphorano)]alkane according to claim 1 wherein m=0.

7. A fluoro-α,ω-bis[(fluoroalkyl)fluorophosphorano)]alkane according claim 1, wherein y=2.

8. A fluoro-α,ω-bis[(fluoroalkyl)fluorophosphorano)]alkane according to claim 1, wherein R₁ and R₂ are fluorine.

9. A process for the preparation of a fluoro-α,ω-bis[(fluoroalkyl)fluorophosphorano)]alkane of formula (I)
(CₙF₂ₙ₊₁₋ₘHₘ)_{y}PF_{4-y}(CR₁R₂)ₓPF_{4-y}(CₙF₂ₙ₊₁₋ₘHₘ)_{y} (I)
in which 1≦n≦8, 0≦m≦2 for n=1 or 2, 0≦m≦4 for 3≦n≦8, 1≦x≦12, 0≦y≦2, and
where R₁ and R₂ are each independently fluorine, hydrogen, alkyl, fluoroalkyl or perfluoroalkyl, and
and each substituent (CₙF₂ₙ₊₁₋ₘHₘ) and the number Y of the substituents on the phosphorus centers PF_{4-y} are each independently selected,
said process comprising converting at least one α,ω-bis(alkylphosphino)alkane into at least one compound of formula (I) by electrolysis in hydrogen fluoride, and optionally purifying and/or isolating a compound of formula I.

10. The process according to claim 9, comprising converting at least one compound of formula (II)
(CₐH₂ₐ₊₁)_{b}P(R¹)_{2-b}(CH₂)_{c}P(R¹)_{2-b}(CₐH₂ₐ₊₁)_{b} (II)
in which R¹=H, Cl or F,
1≦a≦8,
b=0, 1 or 2 and
1≦c≦12,
and/or at least one compound of formula (III)
(CₐH₂ₐ₊₁)_{b}P(R²)_{4-b}(CH₂)_{c}P(R²)_{4-b}(CₐH₂ₐ₊₁)_{b} (III)
in which R²=Cl or F,
1≦a≦8,
b=0, 1 or 2 and
1≦c≦12,
and where ligands (CₐH₂ₐ₊₁), and R¹ and R² in the compounds (II) and/or (III) are each independently selected,
into a compound of formula (I) by electrolysis in hydrogen fluoride, and optionally purifying and/or isolating a compound of formula (I).

11. The process according to claim 9, wherein electrolysis is carried out at a temperature from −20 to +40° C.

12. The process according to claim 9, wherein electrolysis is carried out at an excess pressure of from 0 to 3 bar above atmospheric pressure.

13. The process according to claim 9, wherein electrolysis is carried out at a voltage of from 4 to 8 volts.

14. The process according to claim 9, wherein electrolysis is carried out at a current density of from 0.2 to 5 A/dm².

15. The process according to claim 9, comprising purifying or isolating a compound of formula (I) by extraction, phase separation, distillation or by a combination thereof.

16. The process according to claim 9 wherein electrolysis is carried out using a positive electrode containing nickel.
